(19) United States
(12) Patent Application Publication
(10) Pub. No.: US 2007/0267846 A1
(43) Pub. Date: Nov. 22, 2007

(54) Universal trailer hitch

(76) Inventor: Mary Ann Carraway, Cashiers, NC (US)

Correspondence Address: Robert J. Van Der Wall;Gables One Tower, Suite 1275, 1320 South Dixie Highway, Coral Gables, FL, 33146, US

(21) Appl. No.: 11/437,917

(22) Filed: May 22, 2006

(51) Int. Cl. B60D 1/14

(52) U.S. Cl. 280/495; 280/511

(57) ABSTRACT

The present invention is a universal trailer hitch that can be secured to the structure of the rear of a towing vehicle but connecting to a trunk lid, tailgate or hatchback door of towing vehicle using straps that are ratcheted type about the referenced structure before it is closed to the towing vehicle body. The trailer hitch is designed for rapid consumer attachment to a towing vehicle without using professional installers or tools, and which is universal in the sense that it is adaptable for use with nearly all vehicles. The hitch is also readily detachable from the towing vehicle when not in use and can be detached and stored at all times when not in use. The invention further facilitates the sharing of a trailer hitch among several towing vehicles or several people by selective installation of the trailer hitch on a plurality of vehicles in recognition of the very limited use to which most trailer hitches are exposed.

### BACKGROUND OF THE INVENTION

1. Field of the Invention

The present invention relates to the field of vehicle accessories, and specifically concerns a trailer hitch that may be attached to various vehicles using strapping and ratchets. The strapping is attached to a car trunk lid, tailgate or a hatchback, such as found on sport utility vehicles and other vehicles that have a hatchback configuration.

2. Description of the Prior Art

Most people are familiar with trailer hitches that are attached to the rear of vehicles towing a great variety of trailers. The great majority of these trailer hitches are permanently attached to the towing vehicles by professional installers. Some, however, are temporarily attached to vehicles by companies who rent on a short term temporary basis trailers such as are used for people who are moving from one residence to another. Such trailer hitches are heavy duty units that are also attached to the towing vehicles by professionals employed by the trailer renting companies and using a plurality of tools.

So far as is known to the present inventor, there is no trailer hitch designed for rapid consumer attachment to a towing vehicle without using professional installers or tools, and which is universal in the sense that it is adaptable for use with nearly all vehicles. The exceptions are a few vehicles having a steeply sloped trunk lid such as the VW Beetle, Porshe 911, or Audi TT.

### SUMMARY OF THE INVENTION

Bearing in mind the foregoing, it is a principal object of the present invention to provide a trailer hitch which can be attached to a towing vehicle by a consumer without professional assistance or tools.

Another principal object of the invention is to provide a removable trailer hitch for towing vehicles that is almost universally adapted to virtually any vehicle having a rear trunk, tailgate or hatchback.

Another object of the invention is to provide a trailer hitch that is attachable to a towing vehicle trunk, tailgate or hatchback by using straps and a ratchet tightening device not requiring tools.

A further object of the invention is to provide a universal trailer hitch which is readily detachable from the towing vehicle when not in use and which can be detached and stored at all times when not in use.

A related object of the invention is to preserve a universal trailer hitch from exposure to the elements by allowing it to be stored at all times when not in use in a location free from exposure to the elements.

An additional object of the invention is to provide a universal trailer hitch that is substantially less expensive to purchase than conventional permanent trailer hitches.

Another object of the invention is to facilitate the sharing of a trailer hitch among several towing vehicles or several people by selective installation of the trailer hitch on a plurality of vehicles in recognition of the very limited use to which most trailer hitches are exposed.

A further object of the invention is to facilitate quick and easy installation by attachment of the trailer hitch to easily accessible features on towing vehicles such as the trunk lid, tailgate or hatchback door.

Other objects and advantages will become apparent to those skilled in the art upon reference to the following descriptions and the appended drawings and or photographs.

In accordance with a primary aspect of the present invention there is provided a universal trailer hitch that can be secured to the structure of the rear of a towing vehicle but connecting to a trunk lid, tailgate or hatchback door using straps that are ratcheted type about the referenced structure before it is closed to the towing vehicle body. The hitch itself is comprised of a fulcrum channel having a back plate channel flange, fulcrum channel web, and front plate channel flange. The back plate channel flange is covered by a resilient padding layer to cushion contact between the fulcrum channel and the surface of the trunk lid, tailgate or hatchback door. The front plate channel flange is equipped with two pair of strap slots to interact with the two straps used to fasten the universal trailer hitch to the trunk lid, tailgate or hatchback door.

Welded to the fulcrum channel is a downwardly depending vertical telescoping housing which is preferably square tubing. The vertical telescoping housing has inside dimensions large enough to accommodate a vertical telescoping interior member that is also preferably square tubing having outside dimensions to permit it to slide up and down within the vertical telescoping housing. The vertical telescoping housing includes a ledge welded to its lower surface over which is welded a base plate that is also vertical and substantially within the plane of the front plate channel flange. It is preferably attached to the vertical telescoping housing and vertical telescoping ledge using base plate housing welds. The base plate is perforated with a pair of base plate straps slots, one to the left and one to the right, to also accommodate the straps that attach the universal trailer hitch to the trunk lid, tailgate or hatchback door. It is further perforated with a pair of chain ports to accommodate the safety chains required for use with trailer hitches by law.

The vertical telescoping interior member includes a base to which is preferably attached by welding a hitch arm that is horizontally positioned at the lower end of the vertical interior member. The hitch arm is perforated by a bore used to attach the hitch ball. The hitch ball includes a lower lip beneath which is a hitch ball stem that penetrates the hitch arm bore. The hitch ball stem is threaded on its lower end to accommodate a hitch ball stem nut that fastens the hitch ball to the hitch arm.

The vertical telescoping housing and vertical telescoping interior member are telescoping for the purpose of adjusting the height of the hitch ball to accommodate different heights between the towing vehicle and the trailer to be attached to the universal trailer hitch. The relative position of the vertical telescoping housing and the vertical telescoping interior member is controlled adjustably by a telescoping pin inserted into openings in the vertical telescoping housing and the vertical telescoping interior member. More specifically, the vertical telescoping housing includes at least one pin aperture. The vertical telescoping interior member includes a first pin perforation, a second pin perforation and a third pin perforation of course it is within the contemplation of the inventor to include additional perforations in the structure of the vertical telescoping housing and vertical telescoping interior member as necessary.

The vertical telescoping interior member is slid upwardly or downwardly until arriving of an approximately appropriate height after the universal trailer hitch has been attached to the towing vehicle. The vertical telescoping housing pin aperture and one of the vertical telescoping interior member perforations are aligned and then the telescoping pin is inserted through the aligned openings. After insertion the telescoping pin is fixed into the position by insertion through an opening in its end of a telescoping pin clip.

As noted previously, the universal trailer hitch is attached to a towing vehicle trunk lid, tailgate or hatchback door using a pair of straps that are tightened about the trunk lid, tailgate or hatchback door using ratchets that are disposed within the towing vehicle when the trunk lid, tailgate or hatchback door is closed.

The trailer hitch of the present invention has a design work load limit of approximately 1,100 pounds. This load limit gives it a surprising versatility. Among the things that can be towed using it are a 15 foot Jon boat having a 125 hp outboard motor, a large (750-850 lbs.) motorcycle, an off road dirt bike, an all terrain vehicle (ATV), a jet ski, riding mower, a washer and dryer, a side by side refrigerator, a fir dry one half cord of wood, ten 25 gal. nursery plants, a motorcycle trailer, a 4 foot×6 foot steel mesh trailer, a 4 foot×8 foot steel mesh trailer, a jon boat trailer, and a small cargo trailer.

The invention will be better understood upon reference to the accompanying drawings in which:

### BRIEF DESCRIPTION OF DRAWINGS

FIG. 1 is a partial perspective view showing most of the assembled exterior components of universal trailer hitch.

FIG. 2 is a partial perspective view of the vertical telescoping interior member assembled with adjoining components with the hitch ball.

FIG. 3 is a top plan view of the telescoping pin.

FIG. 4 is a top plan view of the telescoping pin clip.

FIG. 5 is a perspective view of the ratchets and straps.

FIG. 6 is a broken perspective view of universal trailer hitch installed on the trunk lid of a vehicle.

FIG. 7 shows the installation of FIG. 6 with the trunk lid open exposing the position of the ratchets and straps that are disposed inside of the trunk lid after installation.

FIG. 8 is a broken perspective view showing installation of universal trailer hitch on a hatchback vehicle.

### DETAILED DESCRIPTION OF PREFERRED EMBODIMENTS

As required, detailed embodiments of the present invention are disclosed herein. However, it is to be understood that the disclosed embodiments are merely exemplary of the invention which may be embodied in various forms. Therefore, specific structural and functional details disclosed herein are not to be interpreted as limiting, but merely as a basis for the claims appended hereto and as a representative basis for teaching one skilled in the art to variously employ the present invention in virtually any appropriately detailed structure.

References now made to the drawings, wherein like characteristics and features of the present invention shown in the various figures are designated by the same reference numerals.

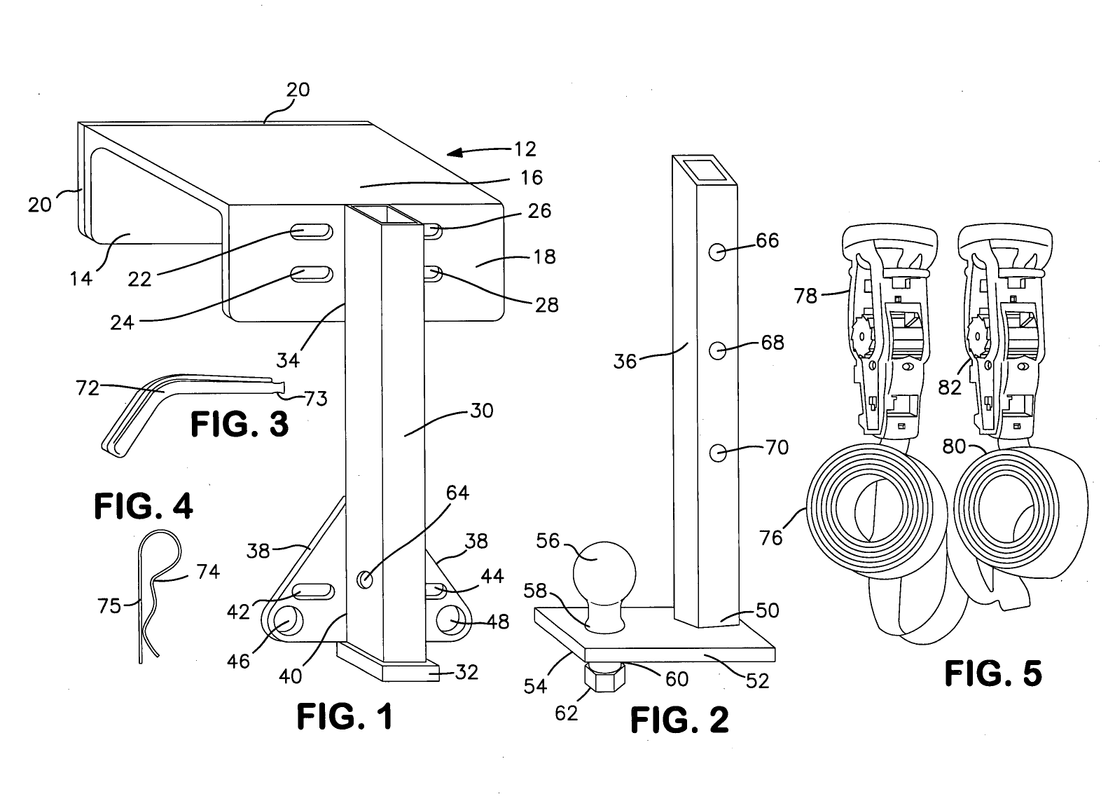

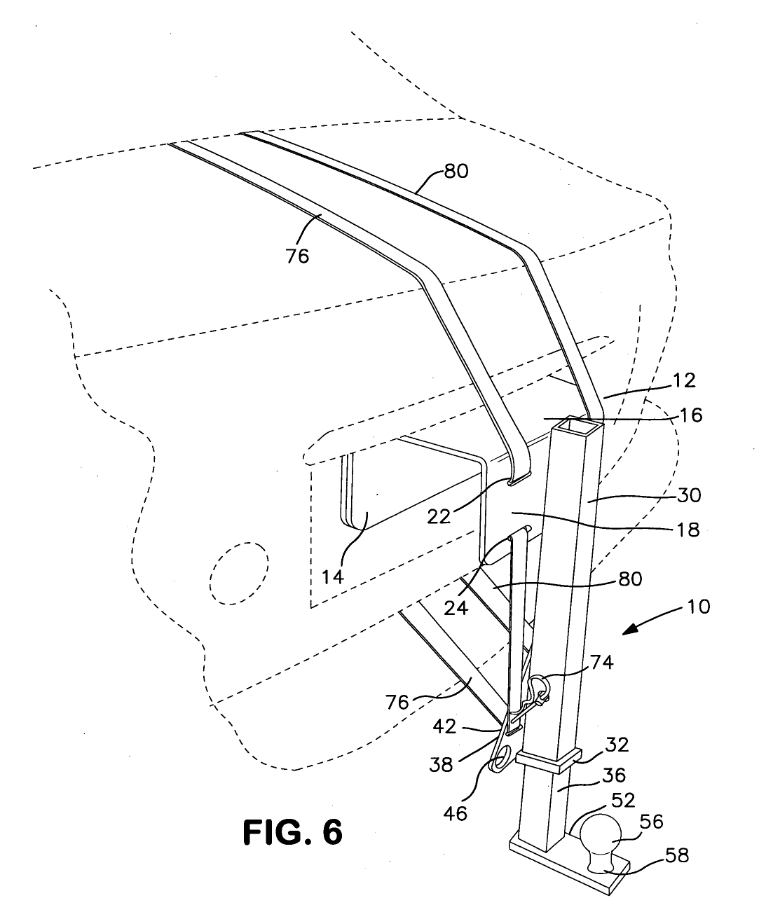

As first seen in FIG. 1, a universal trailer hitch comprised in part of a fulcrum channel 12 having a back plate channel flange 14, fulcrum channel web 16, and front plate channel flange 18. The fulcrum channel 12 is provided with a resilient padding layer 20 to cushion the fulcrum channel 20 when it contacts the exterior of the towing vehicle as best shown in FIGS. 6 & 8 hereafter. The fulcrum channel 12 is provided with a plurality of strap slots. Specifically it includes an upper left channel strap slot 22, a lower left channel strap slot 24, an upper right channel strap slot 26, and a lower right channel strap slot 28.

The fulcrum channel 12 is fixedly attached to a vertical telescoping housing 30, at the lower end of which is vertical telescoping housing ledge 32. Attachment is preferably with channel housing welds 34 on front plate channel flange 18 on either side of vertical telescoping housing 30. Also disposed near the lower end of vertical telescoping housing 30 is base plate 38 which is attached to vertical telescoping housing 30 with base plate housing welds 40 on both sides of vertical telescoping housing 30. Base plate 38 is equipped with left base plate strap slot 42 and right base plate strap slot 44. It is also equipped with chain ports as required by law, specifically left chain port 46 and right chain port 48.

FIG. 2 is a partial perspective view showing vertical telescoping interior member 36 having a vertical telescoping interior member face 50, hitch arm 52, hitch arm base 54, hitch ball 56, hitch ball lip 58, and hitch ball stem 60. The lower end of hitch ball stem 60 is threaded to accommodate hitch ball stem nut 62 which fastens hitch ball assembly 56, 58, and 60 to hitch arm base 54.

FIG. 3 shows a top plan view of telescoping pin 72 having a transverse hole 73 at the end thereof.

FIG. 4 is a top plan view of telescoping pin clip 74 the straight leg of which 75 fits through the transverse hole 73 in telescoping pin 72.

The vertical telescoping housing 30 as seen in FIG. 1 is equipped with vertical telescoping pin aperture 64, also seen in FIG. 1. It cooperates with vertical telescoping interior member first pin perforation 66, second pin perforation 68 and third pin perforation 70 as the later are seen in FIG. 2. That is, vertical telescoping interior member 36 can be slid upwardly and downwardly to accommodate the height of the towing vehicle in comparison to the height of the trailer to be towed with the adjustment being fixed by inserting telescoping pin 72 (FIG. 3) into vertical telescoping housing pin aperture 64 (seen in FIG. 1) and through perforations 66, 68, or 70 (FIG. 2) and through the other side of vertical telescoping housing pin aperture 64. When fully inserted, transverse hole 73 is exposed for insertion of telescoping pin clip 74 straight arm 75.

FIG. 5 is a perspective view of left strap 76 in combination with left strap ratchet 78, and right strap 80 in combination with right strap ratchet 82.

FIG. 6 is a broken perspective view showing installation of the universal trailer hitch 10 with its fulcrum channel web 16 and front plate channel flange 18 in clear view and its back plate channel flange 14 pressed against the license plate of the towing vehicle. Also seen are vertical telescoping housing 30, vertical telescoping housing 30, vertical telescoping interior member 36, base plate 38, left base plate strap slot 42, telescoping pin clip 74, hitch arm 52, hitch ball 56, hitch ball lip 58, upper left channel strap slot 22, lower left strap slot 24, left strap 76, right strap 80, and left chain port 46.

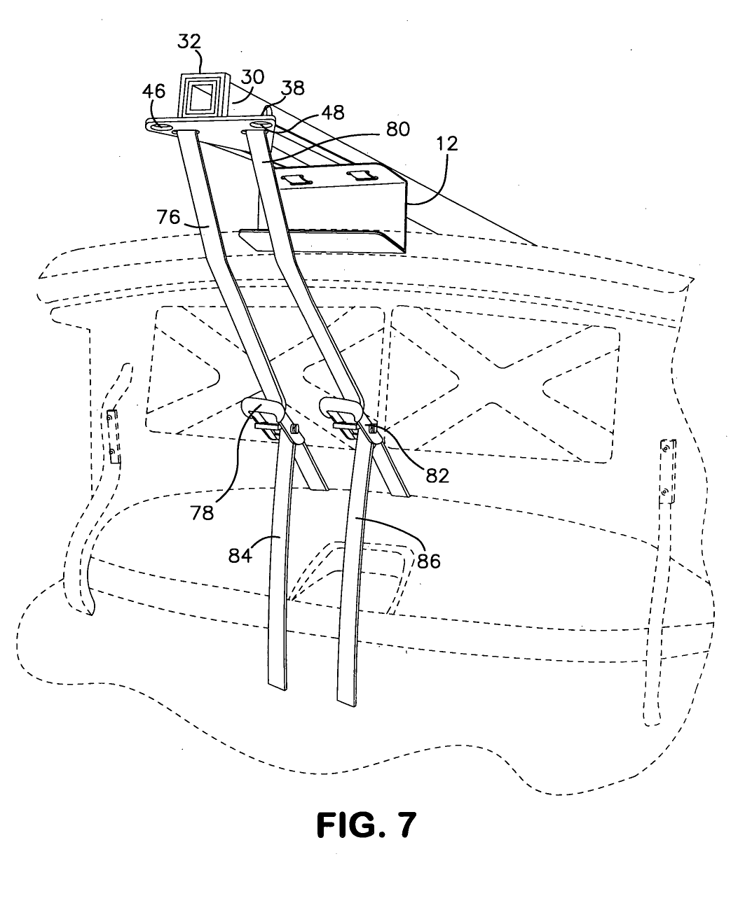

Turning to FIG. 7 a trunk lid from the towing vehicle of FIG. 6 is opened that shows the positioning inside of the trunk of left strap 76 and right strap 80 along with the positioning of left strap ratchet 78 and right strap ratchet 82. Excess strap is shown hanging downward at 84 and 86. Also seen are vertical telescoping housing 30, vertical telescoping housing lip 32, base plate 38, left chain port 46 and right chain port 48, and fulcrum channel 12.

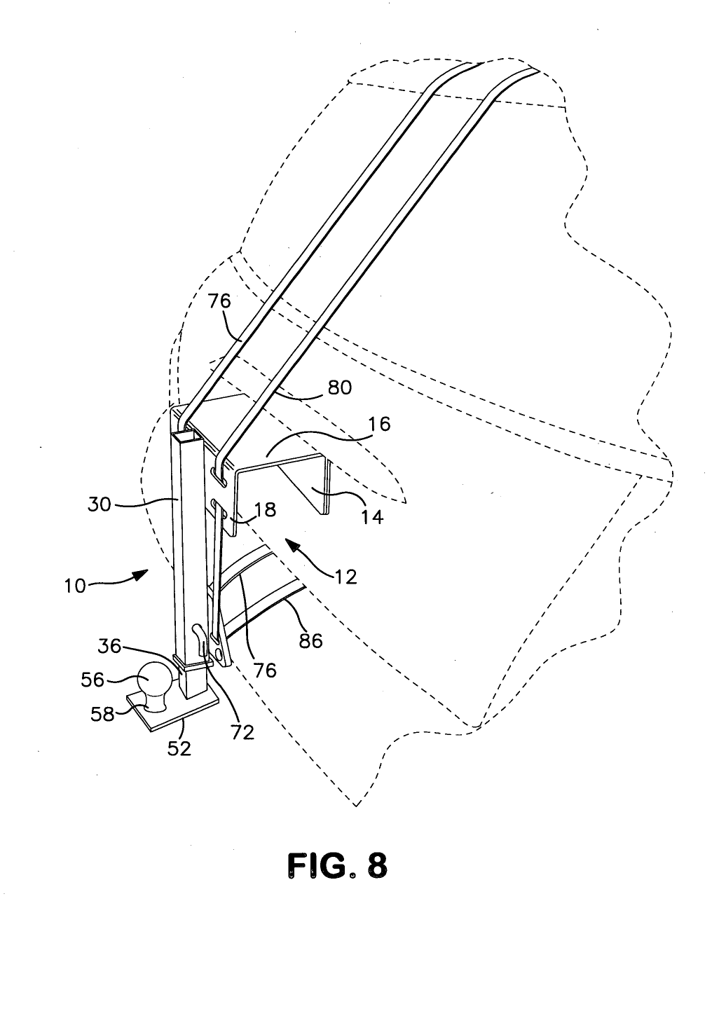

Turning finally to FIG. 8, installation of the universal trailer hitch 10 is shown on a hatchback towing vehicle in broken perspective view. Seen are left strap 76, right strap 80, fulcrum channel 12, fulcrum channel web 16, back plate channel flange 14, front plate channel flange 18, vertical telescoping housing 30, telescoping pin 72, vertical telescoping member 36, hitch arm 52, hitch ball 56, and hitch ball lip 58.

Now the invention has been described, disclosed, illustrated and shown in various terms or certain embodiments or modifications which it has assumed in practice, the scope of the invention is not intended to be, nor should it be deemed to be, limited thereby except other modifications or embodiments as may be suggested by the teachings herein are particularly reserved especially as they fall within the breadth and scope of the claims appended hereto.

What is claimed is:

1. A universal trailer hitch for use with a towing vehicle having a trunk lid, tailgate or hatchback door comprising:
ratchet straps removably connecting the hitch to the trunk, tailgate or hatchback of the towing vehicle;
a fulcrum channel having padding on one flange for contact with the vehicle surface;
a telescoping structure attached to the channel member to provide for height adjustability of the hitch; and
a hitch ball connected to a distal end of the telescoping structure.

2. The hitch of claim 1 which further comprises a base plate attached to the telescoping structure and having slots for the attachment of the straps, and with a front plate flange of the fulcrum channel also having slots for the attachment of the straps.

3. The hitch of claim 2 which further comprises chain ports in the base plate to accommodate safety chains required by law.

4. The hitch of claim 1 in which the fulcrum channel further comprises:
a back plate channel flange, fulcrum channel web, and front plate channel flange.

5. The hitch of claim 1 in which the telescoping structure further comprises:
a downwardly depending vertical telescoping housing preferably square tubing welded to the fulcrum channel and having at least one pin aperture;
a vertical telescoping interior member preferably square tubing having outside dimensions to permit it to slide up and down within the vertical telescoping housing and having a plurality of pin perforations; and
a telescoping pin for selective insertion into the pin aperture of the vertical telescoping housing and the pin perforations of the vertical telescoping interior member.

6. A universal trailer hitch for use with a towing vehicle having a trunk lid, tailgate or hatchback door comprising:
two elongated straps with accompanying ratchets;
a fulcrum channel having a back plate channel flange, fulcrum channel web, and front plate channel flange with the back plate channel flange being covered by a resilient padding layer to cushion contact between the fulcrum channel and the surface of the trunk lid, tailgate or hatchback door, and with the front plate channel flange being equipped with two pair of strap slots to interact with the two straps used to fasten the universal trailer hitch to the trunk lid, tailgate or hatchback door;
a downwardly depending vertical telescoping housing preferably square tubing welded to the fulcrum channel and having at least one pin aperture;
a vertical telescoping interior member preferably square tubing having outside dimensions to permit it to slide up and down within the vertical telescoping housing and having a plurality of pin perforations;
a telescoping pin for selective insertion into the pin aperture of the vertical telescoping housing and the pin perforations of the vertical telescoping interior member;
a vertical base plate preferably welded to the vertical telescoping housing and substantially within the plane of the front plate channel flange, said base plate having strap slots to accommodate the two straps and chain ports to accommodate safety chains;
a hitch arm that is horizontally positioned at a lower end of the vertical interior member which hitch arm is perforated by a bore; and
a hitch ball having a lower lip beneath which is a hitch ball stem that penetrates the bore, the hitch ball stem being threaded on its lower end to accommodate a hitch ball stem nut that fastens the hitch ball to the hitch arm.
